(19) United States
(12) Patent Application Publication
(10) Pub. No.: US 2017/0323150 A1
(43) Pub. Date: Nov. 9, 2017

(54) OBJECT FORMATION IMAGE MANAGEMENT SYSTEM, OBJECT FORMATION IMAGE MANAGEMENT APPARATUS, AND NON-TRANSITORY COMPUTER READABLE MEDIUM

(71) Applicant: FUJI XEROX CO., LTD., Tokyo (JP)

(72) Inventors: Takashi MIURA, Kanagawa (JP); Satoshi TOMITA, Kanagawa (JP)

(73) Assignee: FUJI XEROX CO., LTD., Tokyo (JP)

(21) Appl. No.: 15/336,313

(22) Filed: Oct. 27, 2016

(30) Foreign Application Priority Data
May 6, 2016 (JP) 2016-093048

(51) Int. Cl. G06K 9/00; G06T 17/00; B33Y 50/00; B33Y 30/00; G05B 17/02; H04N 1/00; G06K 9/62

(52) U.S. Cl. CPC G06K 9/00208; H04N 1/00827; G06T 17/00; G06K 9/6267; B33Y 30/00; G05B 17/02; B33Y 50/00; G05B 2219/49023

(57) ABSTRACT

An object formation image management system is provided. Image information containing a specific subject is extracted from image information in which subjects as candidates of a 3D object are. Multiple image-of-interest information which the specific subject is in and which are captured at different capturing viewpoints are extracted from the extracted image information to create design information for object formation by a 3D object formation device. The created design information is output to the 3D object formation device.

### CROSS-REFERENCE TO RELATED APPLICATIONS

This application is based on and claims priority under 35 USC 119 from Japanese Patent Application No. 2016-093048 filed May 6, 2016.

### BACKGROUND

### Technical Field

The present invention relates to an object formation image management system, an object formation image management apparatus, and a non-transitory computer readable medium.

### SUMMARY

According to an aspect of the invention, an object formation image management system is provided. Image information containing a specific subject is extracted from image information in which subjects as candidates of a 3D object are. Multiple image-of-interest information which the specific subject is in and which are captured at different capturing viewpoints are extracted from the extracted image information to create design information for object formation by a 3D object formation device. The created design information is output to the 3D object formation device.

### BRIEF DESCRIPTION OF THE DRAWINGS

Exemplary embodiments of the present invention will be described in detail based on the following figures, wherein:

FIG. 1 is a schematic view illustrating the entirety of an object formation image management system according to an exemplary embodiment;

FIG. 2 is a block diagram illustrating a configuration of an object formation image management control apparatus according to the exemplary embodiment;

FIG. 3 is a functional block diagram illustrating, in detail, respective processings of a first function unit, a second function unit, and a third function unit of the object formation image management control apparatus according to the exemplary embodiment;

FIG. 4 is a view illustrating one example of a relative table created based on images of interest which are extracted in second extraction;

FIG. 5 is a control flowchart illustrating an object formation system main routine executed by the object formation image management control apparatus according to the exemplary embodiment;

FIG. 6 is a control flowchart illustrating an image storing processing routine executed by the first function unit of the object formation image management control apparatus according to the exemplary embodiment;

FIG. 7 is a control flowchart illustrating an object formation image extracting processing routine executed by the second function unit of the object formation image management control apparatus according to the exemplary embodiment;

FIG. 8 is a control flowchart illustrating a design information output processing routine executed by the third function unit of the object formation image management control apparatus according to the exemplary embodiment;

FIGS. 9A to 9C illustrate that images of interest required for 3D object formation are extracted, for example, from images captured with a digital camera by using the object formation image management control apparatus according to an example of an exemplary embodiment, FIG. 9A is a view of received images, FIG. 9B is a view of images which are extracted in first extraction, and FIG. 9C is a view of images of interest which are extracted in the second extraction; and

FIG. 10 is a schematic view illustrating a storage state where a prototype model database stores models in advance for 3D objection formation using the models, according to a modified example of the exemplary embodiment.

### DETAILED DESCRIPTION

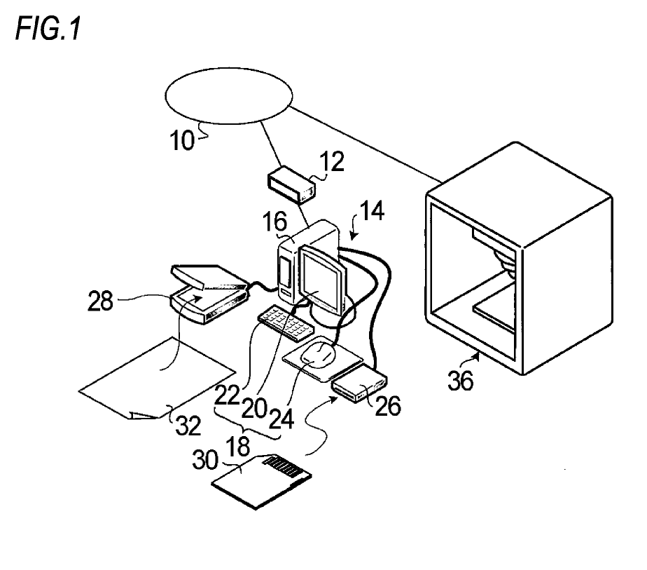

FIG. 1 is a schematic view illustrating the entirety of an object formation image management system according to an exemplary embodiment.

An object formation image management control apparatus 14 is connected to a communication line network 10 through a network I/F 12.

The communication line network 10 is, for example, a local area network (LAN) or an Internet line, and multiple LANs may be connected to each other by a world area network (WAN). Further, each of all communication line networks including the communication line network 10 need not be a wired connection. That is, some or all of the communication line networks may be a wireless communication line network which transmits/receives information wirelessly.

The object formation image management control apparatus 14 includes a main body 16 and a user interface (UI) 18 as a reception unit. The UI 18 includes a monitor 20 as a display, and a keyboard 22 and a mouse 24 as an input operation unit.

Further, a media reader 26 and an image reader 28, which is an example of an acquisition unit and serve as an input source of image information, are connected to the main body 16.

A slot unit into which recording media 30 such as an SD memory card may be inserted is provided in the media reader 26, and image data recorded in the inserted recording media is read and transmitted to the main body 16.

Further, the image reader 28 includes, for example, a document table that positions an original document 32, a scan driving system that scans an image of the original document 32 placed on the document table with light, and a photoelectric conversion element, such as a CCD, that receives transmitted or reflected light through the scanning of the scan driving system and converts the received light into an electric signal.

Herein, the original document 32 on which an image is formed is positioned on the document table, and the scan driving system operates, and as a result, the image is read by the photoelectric conversion element and transmitted to the main body 16.

Further, the image may be received from the communication line network 10 through the network I/F 12 serving as the acquisition unit.

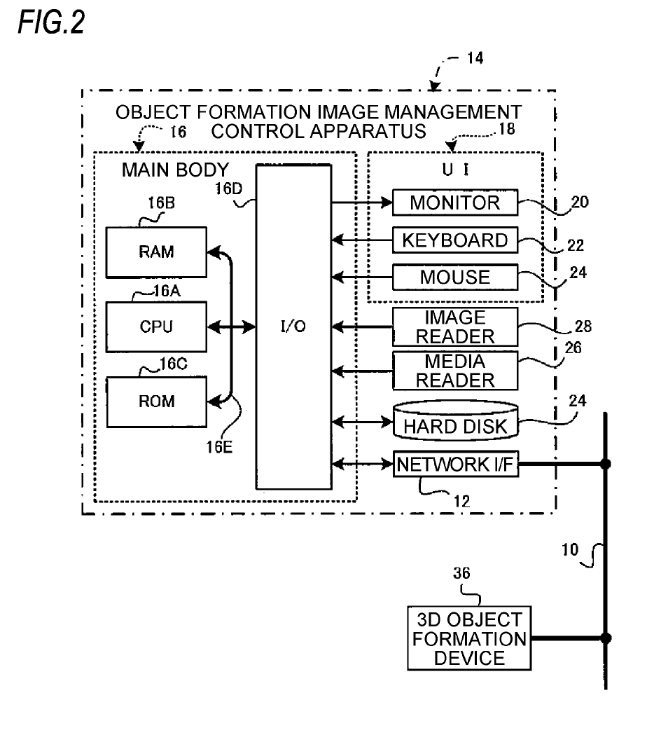

As illustrated in FIG. 2, the main body 16 of the object formation image management control apparatus 14 includes a CPU 16A, a RAM 16B, a ROM 16C, an input/output unit (I/O) 16D, and a bus 16E, such as a data bus or a control bus, that connects the respective units.

As described above, the network I/F 12, the UI 18 (the monitor 20, the keyboard 22, and the mouse 24), the media reader 26, and the image reader 28 are connected to the I/O 16D.

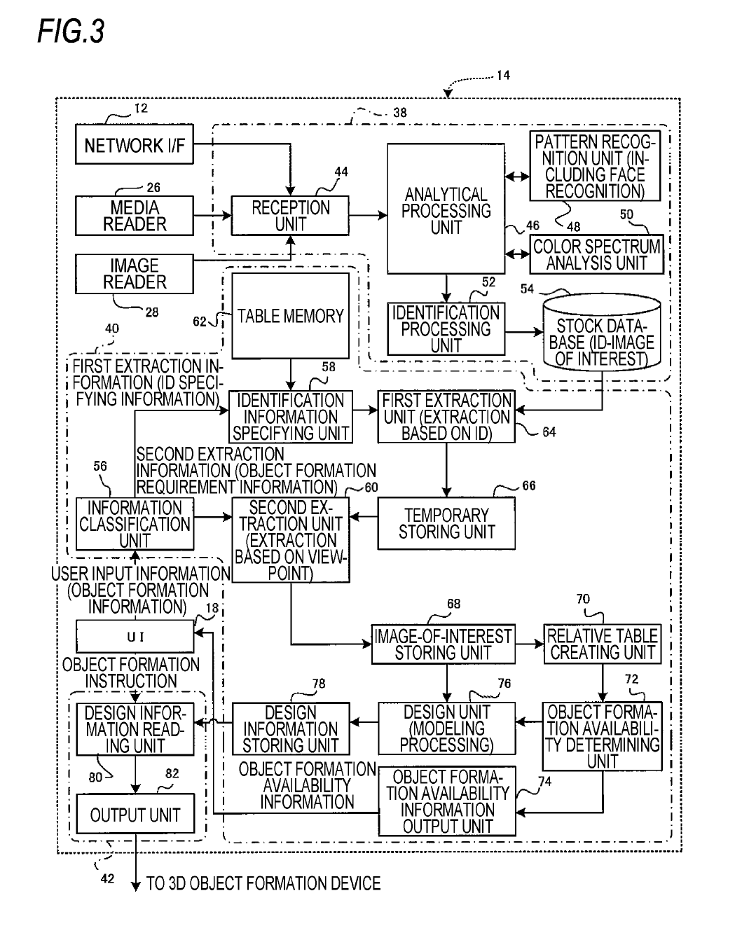

Further, a hard disk 24 as a large-scale recording medium is connected to the I/O 16D and serves as a stock database 54, a temporary storing unit 66, an image-of-interest storing unit 68, and a design information storing unit 78 (see FIG. 3 for each unit) to be described below.

A program for object formation image management control is recorded in the ROM 16C. When the object formation image management control apparatus 14 is started up, the program is read from the ROM 16C and executed by the CPU 16A. Further, the object formation image management control program may be recorded in the hard disk 24 or another recording medium in addition to the ROM 16C.

As illustrated in FIGS. 1 and 2, a 3D object formation device 36 (hereinafter, may be referred to as “3D printer 36”) is connected to the communication line network 10. The 3D object formation device 36 may be directly connected to the object formation image management control apparatus 14 through a dedicated signal line.

As the 3D object formation device 36, multiple types of 3D object formation devices which are different in method for forming an object are present. The forming methods include vat photopolymerization, binder jetting, material extrusion, material jetting, sheet lamination, powder bed fusion, and directed energy deposition.

FIG. 1 illustrates one example of external appearance of the 3D object formation device 36, but the 3D object formation device 36 may have various external appearance and sizes depending on factors including the forming method, a size and a range of an object to be formed, and a type of applied material (filament).

Further, in FIGS. 1 and 2, a single 3D object formation device 36 is illustrated, but multiple types of 3D object formation devices 36 may be connected and selected according to a formation target.

In the 3D object formation device 36, a material applicable to forming an object varies depending on types of the respective forming method.

Hereinafter, one example of a relationship between the types of the forming method and applied materials of the respective forming methods is illustrated (forming method—applied material).
(1) Vat photopolymerization—UV setting resin
(2) Binder jetting—gypsum, ceramics, sand, calcium, and plastic
(3) Material extrusion—acrylonitrile butadiene styrene rein (ABS), polylactic acid (PLA), nylon 12, polycarbonate (PC), and polyphenylsulfone (PPSF)
(4) Material jetting—UUV setting resin, fat, wax, and solder
(5) Sheet lamination—paper, resin sheet, and aluminum sheet
(6) Powder bed fusion—engineering plastic, nylon, and metal
(7) Directed energy deposition—metal

In manufacturing a 3D object, when, for example, a client goes to a photography studio designated by a provider who performs an operation of manufacturing 3D objects, and captures an object by a dedicated 3D scanner which senses concavity and convexity of the object and acquires the sensed concavity and convexity as 3D data, there is no problem. On the other hand, when the client sends an image which becomes a material for manufacturing the 3D object, the client himself needs to create a required image.

However, for example, it is difficult to extract minimum images required for manufacturing the 3D object from image data captured by a digital camera. In particular, under a current situation, the number of image data saved in the digital camera or the recording media may reach several hundreds to several thousands, and it would be burdensome to extract images manually.

The object formation image management control apparatus 14 of the exemplary embodiment has a function (a first function unit 38 illustrated in FIG. 3) of acquiring images which become elements for forming a 3D object by the 3D object formation device 36, a modeling function (a second function unit 40 illustrated in FIG. 3) of extracting an object (images of interest), which is to be formed as the 3D object, from the acquired images and creating design information for manufacturing the 3D object based on the extracted images of interest, and a function (a third function unit 42 illustrated in FIG. 3) of outputting the design information designed by the modeling function to a specific 3D object formation device 36 according to an object formation instruction.

FIG. 3 is a functional block diagram illustrating, in detail, respective processings of the first function unit 38, the second function unit 40, and the third function unit 42 of the object formation image management control apparatus 14 according to the exemplary embodiment. It should be noted that a hardware configuration of the object formation image management control apparatus 14 is not limited to the one shown in FIG. 3.

(First Function Unit 38)

As illustrated in FIG. 3, the network I/F 12, the media reader 26, and the image reader 28 are connected to a reception unit 44 as the acquisition unit.

The reception unit 44 receives image data received through the network I/F 12, image data read from the recording media 30 (see FIG. 1) inserted into the slot of the media reader 26, and image data read from the original document 32 (see FIG. 1) placed on the document table of the image reader 28.

The reception unit 44 is connected to an analytical processing unit 46, and the received image data is transmitted to the analytical processing unit 46.

A pattern recognition unit 48 and a color spectrum analysis unit 50 are connected to the analytical processing unit 46, and a pattern recognition processing and a color spectrum analysis processing are executed with respect to the images received by the reception unit 44.

That is, one example of the pattern recognition processing extracts an image matching a pattern which is stored in advance. For example, it is determined which genre among a person, an animal, a plant, a still object, a food material, a vehicle, and a building each image belongs to, and a type thereof is further subdivided.

Further, one example of the color spectrum analysis processing analyses distribution of colors of each pattern-recognized image to thereby, for example, determine whether a person having the same body type is the same person based on colors of a cloth which the person wears.

The analytical processing unit 46 is connected to an identification processing unit 52. The analytical processing unit 46 classifies images of interest which are obtained by performing the pattern recognition for one image, links identical images of interest to each other regardless of capturing viewpoints and sizes among multiple images, and transmits the images of interest to the identification processing unit 52. The identification processing unit 52 assigns identification information (ID) to the identical images of interest which are linked to each other and stores the images of interest into the stock database 54 as a storing unit together. The first function unit 38 of the object formation image management control apparatus 14 performs processings up to storing the images of interest in the stock database 54 in association with IDs.

(Second Function Unit 40)

As illustrated in FIG. 3, the UI 18 is connected to an information classification unit 56. A user inputs first extraction information and second extraction information to the UI 18.

The first extraction information is ID specifying information that specifies the identification information (ID) for specifying a subject of which 3D formation is desired. For example, when the subject is a person, the first extraction information may include a name which is registered in advance in association with the identification information (ID).

The second extraction information is object formation requirement information specifying a requirement of manufacturing the 3D object. For example, the second extraction information may include external features including precision of formation and the size (scale). Capturing viewpoints of the subject which are to be extracted from the images are specified based on the object formation requirement. The capturing viewpoints are typically a front view, a back view, a right side view, a left side view, a top view, and a bottom view of the subject. It should be noted that all images captured at such six capturing viewpoints need not necessarily provided. If there are views (an enlarged view, a perspective view, a plane view, and the like) supplementing the shortage, the number of capturing viewpoints may be less than six.

For example, if the object formation requirement information includes such a requirement that when a target is human, a body may be coarse so long as a face is precise, an image of a face part may be extracted and the body may adopt a predetermined model.

Further, a ratio of an occupancy area of an image of interest to an entire area of an image may be determined in advance (e.g., 10% or more).

The information classification unit 56 is connected to an identification information specifying unit 58 and a second extraction unit 60 as a second extraction unit. Herein, among the information classified by the information classification unit 56, the first extraction information is transmitted to the identification information specifying unit 58, and the second extraction information is transmitted to the second extraction unit 60.

A table memory 62 is connected to the identification information specifying unit 58. The table memory 62 stores a table indicating a correspondence relationship between the first extraction information and the identification information (ID). Herein, when receiving the first extraction information, the identification information specifying unit specifies the identification information (ID) corresponding to the first extraction information based on the table stored in the table memory 62.

The identification information specifying unit 58 is connected to a first extraction unit 64 as a first extraction unit and transmits the specified identification information (ID) to the first extraction unit 64.

The first extraction unit 64 is connected to the stock database 54. When receiving the identification information (ID), the first extraction unit 64 extracts the images, which the subject (image of interest) is in and which the identification information (ID) is assigned to, from the stock database 54 and stores the extracted images in the temporary storing unit 66.

The stock database 54 is a database of multiple images, and the multiple images are extracted. Since the first extraction unit 64 exhaustively extracts the images of interest to which the identification information (ID) is assigned regardless of states (such as a direction and a size) of the images of interest, the extracted images may include images in which images of interest having the same direction or the same size are or images in which images of interest are in an extremely small state (e.g., the ratio of the occupancy area less than 10%) with respect to an angle of view.

The second extraction unit 60 extracts the images of interest from the temporary storing unit 66 based on the second extraction information. That is, the second extraction unit 60 extracts the multiple images of interest that are captured with the capturing viewpoints and the sizes, which are required for expressing the external feature, and that are captured at minimum required capturing viewpoint sites and transmits the extracted images of interest to the image-of-interest storing unit 68.

When the image-of-interest storing unit 68 receives all the images of interest from the second extraction unit 60, the image-of-interest storing unit 68 transmits the images of interest to a relative table creating unit 70.

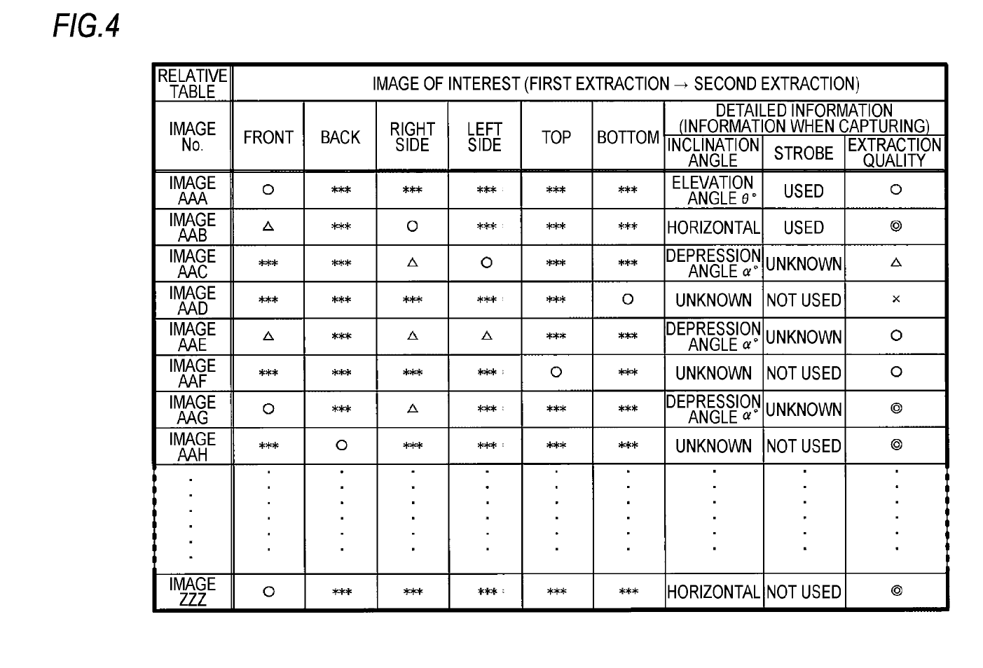

The relative table creating unit 70 is configured to create a capturing information list of the respective image as illustrated in FIG. 4.

As illustrated in FIG. 4, a relative table is classified into items including an image number (No.) specifying an image of interest, the capturing viewpoint, and detailed information. For example, it can be seen that an image AAA (No. 0012) represents a state in which the capturing viewpoint is a front side and the detailed information indicates that an inclination angle is an elevation angle θ°, a strobe is used for capturing, and a focus state is good (∘).

Herein, the capturing viewpoint may be set in a wide-angle predetermined allowance range, and for example, the front side need not strictly face the subject.

Further, as the inclination angle, it is possible to acquire, for example, information (while a state in which a camera is horizontal is defined as 0°, an upward angle is an elevation angle and a downward angle is a depression angle) of an inclinometer built in the digital camera which performs capturing.

Further, the focus state is classified into approximately 4 grades of best (⊚), good (∘), normal (Δ), and mismatch (×). The grades are not limited to this example.

Further, if there is information useful for manufacturing the 3D object, such information may be additionally written in the detailed information.

As illustrated in FIG. 3, when the relative table creating unit 70 creates the relative table (see FIG. 4), information on the relative table is transmitted to an object formation availability determining unit 72.

The object formation availability determining unit 72 determines whether it is possible to manufacture the 3D object, based on the created relative table.

That is, when the number of capturing viewpoints of the extracted images is equal to or larger than the minimum required capturing viewpoints as in the relative table of FIG. 4, information is sufficient for manufacturing the 3D object, and the object formation availability determining unit 72 determines that the object formation is available.

Meanwhile, unlike the relative table of FIG. 4, when the number of capturing viewpoints of the extracted images is small (e.g., in the case of three capturing viewpoints of image AAA, image AAF, and image AAH), information is insufficient for manufacturing the 3D object, and the object formation availability determining unit 72 determines that the object formation is unavailable.

A determination result of the object formation availability determining unit 72 is transmitted to an object formation availability information output unit 74 and a design unit 76 as a creation unit.

The object formation availability information output unit 74 transmits message information for notifying the object formation availability of the UI 18, and the message is displayed on the UI 18 (the monitor 20 illustrated in FIG. 1).

For example, a message such as “A design drawing required for 3D objection formation is being created.”, “Images required for the 3D object formation are insufficient. Do it once again or add images.” is displayed on the monitor 20. Further, the notification is not limited to displaying a message and may be made through other notification ways such as a warning sound, a voice, and a color signal.

When information indicating that it is determined that the object formation is unavailable is input to the design unit 76 from the object formation availability determining unit 72, designing is not executed. Meanwhile, when the information indicating that it is determined that the object formation is available is input to the design unit 76 from the object formation availability determining unit 72, the design unit acquires the images of interest stored in the image-of-interest storing unit 68 and designs the 3D object formation (executes the modeling processing).

Design information created by the modeling processing executed by the design unit 76 is stored in the design information storing unit 78.

(Third Function Unit 42)

As illustrated in FIG. 3, the UI 18 is connected to a design information reading unit 80.

When the design information reading unit 80 receives the object formation instruction from the UI 18, the design information reading unit 80 reads the design information from the design information storing unit 78 based on the identification information (ID) indicated by the object formation instruction.

The design information read by the design information reading unit 80 is transmitted to a specific 3D object formation device 36 through the output unit 82.

The 3D object formation device 36 manufactures the 3D object based on the received design information.

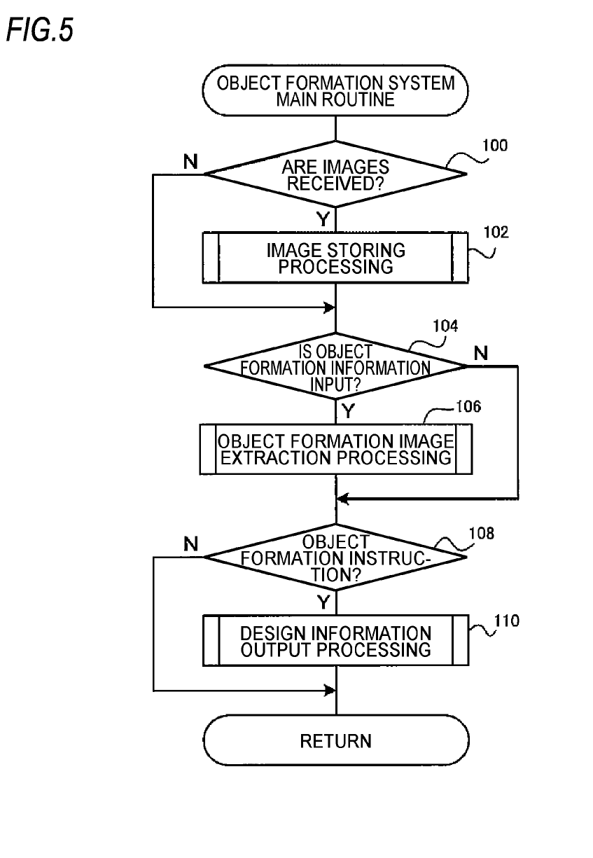

Hereinafter, an operation of the exemplary embodiment will be described with reference to the flowcharts of FIGS. 5 to 8.

FIG. 5 is a control flowchart illustrating an object formation system main routine executed by the object formation image management control apparatus 14.

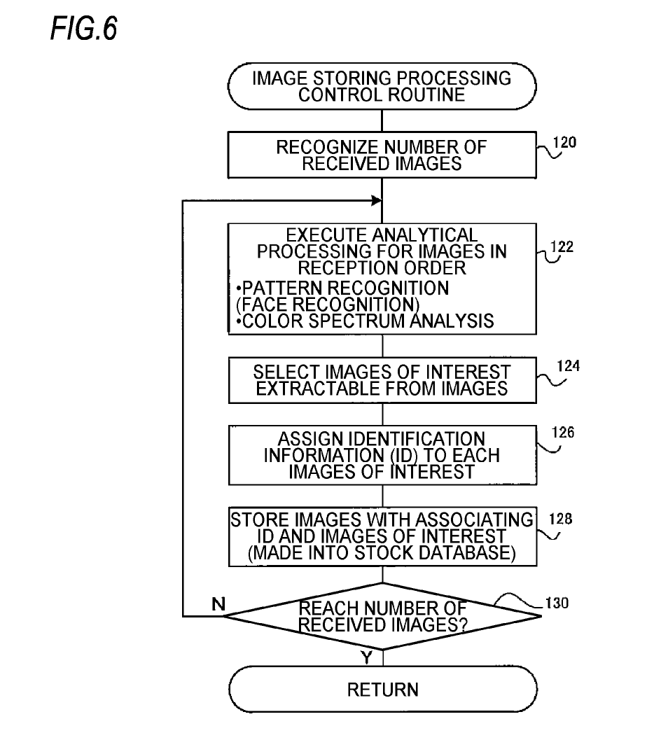

In step 100, it is determined whether the images are received from the network I/F 12, the media reader 26, or the image reader 28. If it is determined that the images are received, the process proceeds to step 102, an image storing processing (see FIG. 6, described below in detail) is executed, and the process proceeds to step 104. If it is determined that the images are not received in step S100, the process proceeds to step 104.

The image storing processing corresponds to the processing executed by the first function unit 38 of the exemplary embodiment.

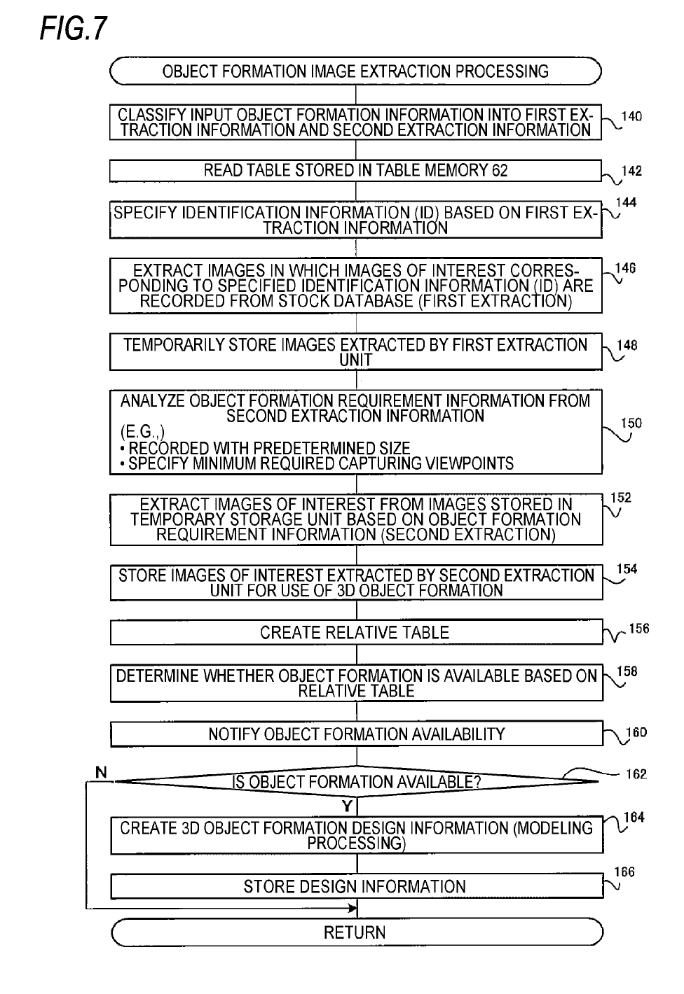

In step 104, it is determined whether or not the object formation information is input by the UI 18. If it is determined that the object formation information is input, the process proceeds to step 106, an object formation image extraction processing (see FIG. 7, described below in detail) is executed, and the process proceeds to step 108. Further, if it is determined that the object formation information is not input in step S104, the process proceeds to step 108.

The object formation image extraction processing corresponds to the processing executed by the second function unit 40 of the exemplary embodiment.

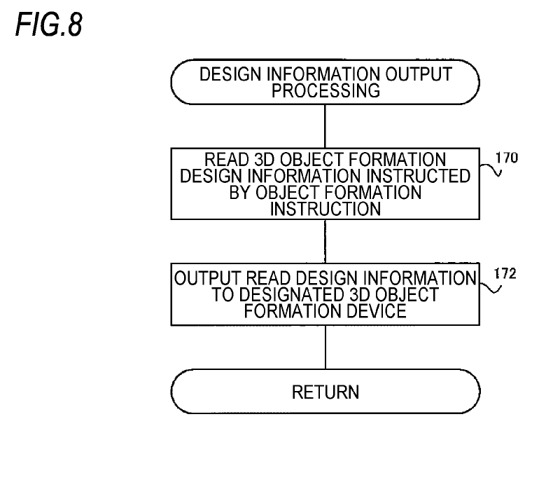

In step 108, it is determined whether the object formation instruction is input by the UI 18. If it is determined that the object formation instruction is input, the process proceeds to step 110, a design information output processing (see FIG. 8, described below in detail) is executed, and the routine ends. If it is determined the object formation instruction is not input in step S108, the routine ends.

(Image Storing Processing)

FIG. 6 is a control flowchart illustrating the image storing processing routine executed by the first function unit 38 of the object formation image management control apparatus 14.

In step 120, the number of images received by the reception unit 44 is recognized. Then, the process proceeds to step 122, and an analytical processing is performed for the images in a reception order.

As the analytical processing, the pattern recognition (including the face recognition) and the color spectrum analysis are primarily executed.

In next step S124, based on a result of the analytical processing, multiple subjects being in the images are distinguished, and an image of interest is selected. The selected image of interest may be a single image or multiple images.

In next step 126, the identification information (ID) is assigned to each of the selected single or multiple images of interest, and the process proceeds to step 128.

In step 128, the images are stored in the stock database 54 with the identification information (ID) being associated with the image (s) of interest, and the process proceeds to step 130.

In step 130, it is determined whether the number of images from which the images of interest are selected reaches the number of received images. If negative determination is made, it is further determined that there remains an image from which an image of interest is not selected, the process proceeds to step 122 and the above steps are repeated.

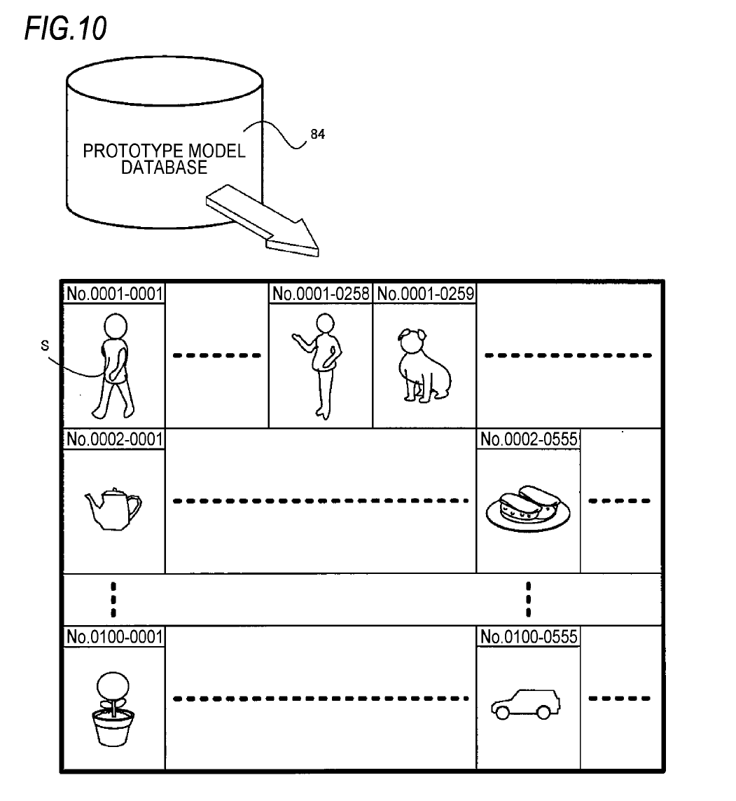

Further, if positive determination is made in step 130, it is further determined that selecting the images of interest from all of the received images ends, and the routine ends. Further, whenever selecting an image of interest for one image ends, the process may return to a main routine (see FIG. 10).

(Object Formation Image Extraction Processing)

FIG. 7 is a control flowchart illustrating the object formation image extraction processing routine executed by the second function unit 40 of the object formation image management control apparatus 14.

In step 140, the input object formation information is classified into first extraction information and second extraction information.

In next step 142, the identification information specifying unit 58 reads the table stored in the table memory 62. Then, the process proceeds to step 144, and the identification information specifying unit 58 specifies the identification information (ID) based on the first extraction information.

In next step 146, images in which images of interest corresponding to the specified identification information (ID) are stored are extracted from the stock database 54 (first extraction), and the process proceeds to step 148.

In step 148, the images extracted by the first extraction unit 64 are temporarily stored in the temporary storing unit 66. Then, the process proceeds to step 150, and object formation requirement information is analyzed from the second extraction information. Examples of the object formation requirement information include such information as an image of interest recorded with a predetermined size and specifying minimum required capturing viewpoints.

In next step 152, the images of interest are extracted from the images temporarily stored in the temporary storing unit 66 (second extraction) based on the object formation requirement information, and the process proceeds to step 154.

In step 154, the images of interest extracted by the second extraction unit 60 are stored in the image-of-interest storing unit 68 for the use of the 3D object formation.

In next step 156, the relative table (see FIG. 4) is created based on the images of interest stored in the image-of-interest storing unit 68. The process proceeds to step 158, and it is determined whether the object formation is available based on the created relative table. The process proceeds to step 160, whether the object formation is available is notified to the UI 18, and the process proceeds to step 162.

In step 162, it is determined whether the objection formation is available. If it is determined that the object formation is available, the process proceeds to step 164 and design information for the 3D object formation is created (modeling processing), the process proceeds to step 166, the design information is stored in the design information storing unit 78, and the routine ends. Further, when it is determined the object formation is not available in step S162, the routine ends.

In the modeling processing, for example, 2D data is put on respective planes corresponding to a 3D coordinate system, and when a position of a common point is specified in at least two pieces of 2D data, a position on the 3D coordinate system corresponding to the common point is calculated based on information on the at least two specified points.

(Design Information Output Processing)

FIG. 8 is a control flowchart illustrating the design information output processing routine executed by the third function unit 42 of the object formation image management control apparatus 14.

In step 170, when the design information reading unit 80 receives the object formation instruction from the UI 18, the design information reading unit 80 reads instructed design information for the 3D object formation from the design information storing unit 78.

In next step 172, the read design information is output to the 3D object formation device 36 by the output unit 82, and the routine ends.

### EXAMPLE

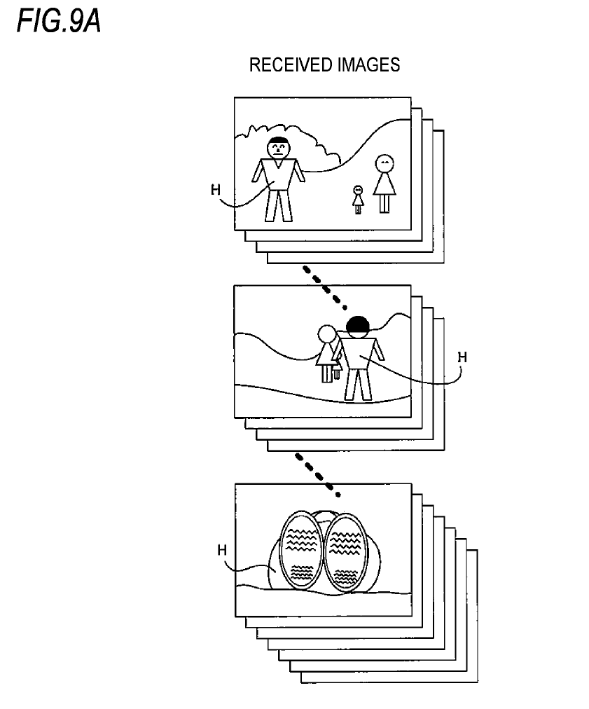

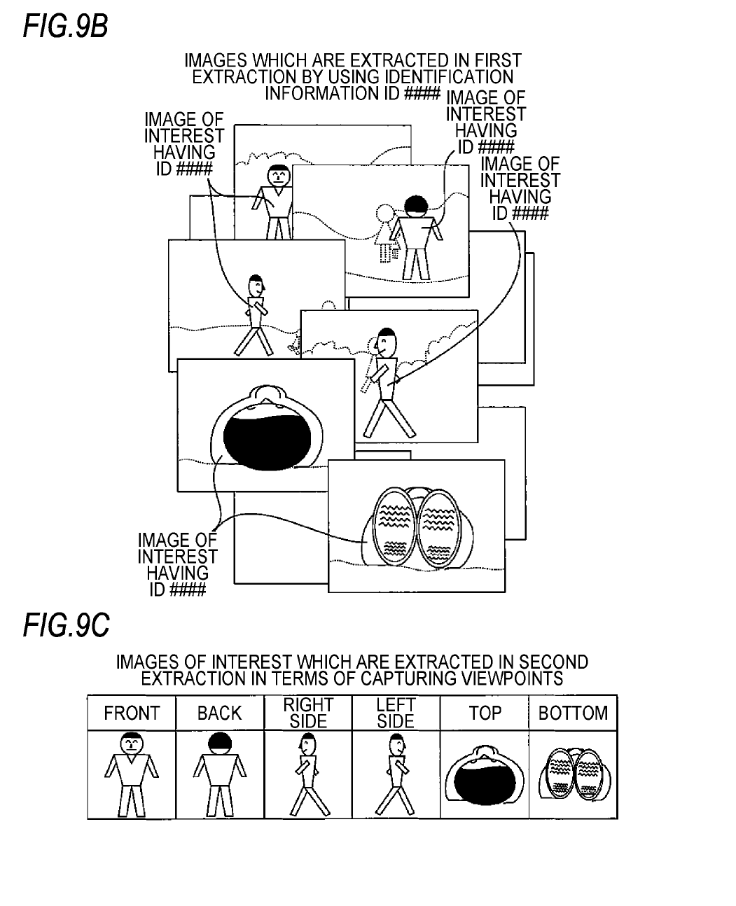

FIGS. 9A to 9C illustrate an example in which images of interest required for 3D object formation are extracted, for example, from images captured with a digital camera, by using the object formation image management control apparatus 14 of the exemplary embodiment.

An object of the example is to manufacture a 3D object of a specific person H.

As illustrated in FIG. 9A, the person H are dotted in motile captured images.

The person H is stored in the stock database 54 of the first function unit 38 (see FIG. 3) in advance.

Herein, identification information (ID) of the person His specified based on the first extraction information input by the UI 18, and as illustrated in FIG. 9B, images which the person H is in are extracted (first extraction).

In the first extraction, since all images which the person H is in at a predetermined size are extracted, excessive images maybe extracted so as to include a case where the person H is dark, a case where the person H is not in focus, a case where the person H overlaps with another person, and a case where a direction in which the person H faces is unclear.

Meanwhile, capturing viewpoints required as an object formation requirement are determined based on the second extraction information input by the UI 18, and images of interest are extracted (second extraction) from the image extracted by the first extraction shown in FIG. 9B.

Herein, as illustrated in FIG. 9C, six images of interest which are obtained by capturing at six capturing viewpoints, i.e., at six capturing viewpoints of front, back, right side, left side, top and bottom are extracted.

As illustrated in FIG. 9C, if a front view, a back view, a right side view, a left side view, a top view and a bottom view (six capturing viewpoints) are obtained, the modeling processing is executed, and the design information is transmitted to the 3D object formation device 36 (see FIG. 1) based on the object formation instruction from the UI 18.

### MODIFIED EXAMPLE

In the exemplary embodiment (including the example), for example, a specific person is extracted from a large quantity of images captured with the digital cameras based on the identification information (ID) (first extraction). Further, the images of interest are extracted from the images extracted by the first extraction based on the object formation requirement information (second extraction). If the 3D object formation is available by using the images of interest extracted in the second extraction, the modeling processing is executed, and the design information for manufacturing the 3D object is transmitted to the 3D object formation device 36.

In a modified example, as a partial memory area of the hard disk 24 of FIG. 2, a prototype model database 84 is provided as a prototype model storing unit as illustrated in FIG. 10.

Multiple models are registered in advance in the prototype model database 84 by a type, a shape, and a posture of the 3D object.

For example, Model No. 0001-0001 is a model S in which a person walks, and this model is selected in manufacturing an object.

On the other hand, the object formation image management control apparatus 14 finally extracts the images of interest illustrated in FIG. 9C based on the first extraction information and the second extraction information input from the UI 18.

In this case, the person who stops (stands), the person who walks, and the person who sleeps are in the images of interest of FIG. 9C.

Then, the modeling processing is executed, which applies the images of interest to the selected model while the selected model is used as a basic type.

As a result, it is possible to manufacture the 3D object in which the person H (see FIG. 9A) walks regardless of a state of the images of interest.

Further, in the exemplary embodiment (including the example and the modified example), still images captured with the digital camera or a smartphone are used. Alternatively, target images may be a moving image or an illustration image. Further, in the case where proprietary right such as copyright is not infringed, for example, in the case of personal use, the target images may be images received from the public radio wave or a communication line network.

(Simplification of Identification Processing)

Further, in the exemplary embodiment, the analytical processing unit 46, the pattern recognition unit 48, and the color spectrum analysis unit 50 execute an identification processing to specify the subject for the 3D object formation from the captured images and assign the identification information. Alternatively, the identification processing may be simplified as follows.

“Simplification 1”

In a case in which a single subject which is a target of 3D object formation is in one image, an identification code (for example, a barcode) in which identification information is encrypted in a capturing area may be captured together with the subject, and the barcode may be decoded to acquire the identification information.

“Simplification ”

In the case where a capturing apparatus (for example, the digital camera) can perform focusing on multiple subjects which are different in depth of field and can basically perform single capturing but potentially execute capturing multiple times to record multiple image information in a state in which every subject is in focus, the capturing apparatus may assign an identification code to every subject which is in focus.

“Simplification 3”

When a specific group is captured, wireless tags may be added to, for example, cloths of persons who belong to the group. In this case, when information from the wireless tags are associated with the persons at a time of capturing, even if multiple persons are captured in one image, the respective persons may be identified by the barcodes.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An object formation image management system, wherein
image information containing a specific subject is extracted from image information in which subjects as candidates of a 3D object are,
multiple image-of-interest information which the specific subject is in and which are captured at different capturing viewpoints are extracted from the extracted image information to create design information for object formation by a 3D object formation device, and
the created design information is output to the 3D object formation device.

2. The object formation image management system according to claim 1, wherein the image-of-interest information is applied to a prototype model of which a pose is determined in advance, to create the design information.

3. The object formation image management system according to claim 1, wherein it is determined whether 3D object formation is available based on the image-of-interest information, and a determination result is notified.

4. The object formation image management system according to claim 2, wherein it is determined whether 3D object formation is available based on the image-of-interest information, and a determination result is notified.

5. An object formation image management apparatus comprising:
an acquisition unit that acquires image information;
a storing unit that stores image information in which a subject as a candidate of a 3D object is, in association with identification information to identify the subjects from the image information acquired by the acquisition unit;
a reception unit that receives the identification information and object formation requirement information of a subject to be reflected on the 3D object;
a first extraction unit that extracts image information including the subject corresponding to the identification information received by the reception unit from the storing unit;
a second extraction unit that extracts multiple image-of-interest information, which a subject meeting the object formation requirement information received by the reception unit is in and which is captured at different capturing viewpoints, from the image information extracted by the first extraction unit; and
a creating unit that creates design information to form the image-of-interest information, which are extracted by the second extraction unit, by a 3D object formation device.

6. The object formation image management apparatus according to claim 5, further comprising:
a prototype model storing unit that stores model information on a model which becomes a prototype model of the 3D object, wherein
the reception unit receives the model information and the creating unit applies the image-of-interest information extracted by the second extraction unit to the model information to create the design information.

7. The object formation image management apparatus according to claim 5, further comprising:
a determination unit that determines whether 3D object formation is available based on the image-of-interest information extracted by the second extraction unit; and
a notification unit that notifies a determination result of the determination unit.

8. The object formation image management apparatus according to claim 6, further comprising:
a determination unit that determines whether 3D object formation is available based on the image-of-interest information extracted by the second extraction unit; and
a notification unit that notifies a determination result of the determination unit.

9. A non-transitory computer readable medium storing a program that causes a computer to function as an object formation image management apparatus comprising:
an acquisition unit that acquires image information;
a storing unit that stores image information in which a subject as a candidate of a 3D object is, in association with identification information to identify the subjects from the image information acquired by the acquisition unit;
a reception unit that receives the identification information and object formation requirement information of a subject to be reflected on the 3D object;
a first extraction unit that extracts image information including the subject corresponding to the identification information received by the reception unit from the storing unit;
a second extraction unit that extracts multiple image-of-interest information, which a subject meeting the object formation requirement information received by the reception unit is in and which is captured at different capturing viewpoints, from the image information extracted by the first extraction unit; and
a creating unit that creates design information to form the image-of-interest information, which are extracted by the second extraction unit, by a 3D object formation device.
